(19) United States
(12) Patent Application Publication
(10) Pub. No.: US 2026/0153345 A1
(43) Pub. Date: Jun. 4, 2026

(54) APPARATUS AND METHOD FOR DISPLAYING A ROUTE USING DRAWING GESTURES

(71) Applicant: HYUNDAI AUTOEVER CORP., Seoul (KR)

(72) Inventors: Min Kyeong Seong, Seoul (KR); Jong Hoon Kim, Seoul (KR); Yeon Woong Kim, Seoul (KR); Hee Su Kim, Seoul (KR)

(73) Assignee: HYUNDAI AUTOEVER CORP., Seoul (KR)

(21) Appl. No.: 19/392,998

(22) Filed: Nov. 18, 2025

(30) Foreign Application Priority Data
Dec. 4, 2024 (KR) 10-2024-0178281

(51) Int. Cl. G01C 21/36

(52) U.S. Cl. CPC G01C 21/3626; G01C 21/3676

(57) ABSTRACT

A method for displaying a route of a navigation terminal by using a drawing gesture includes determining a first route from a departure point to a destination by receiving a drawing gesture for determining the first route and displaying information on the first route. The drawing gesture is formed by free movement of a touch point on a touch display of the navigation terminal that is displaying a map, and the free movement is movement of a touch point that is not limited to a road included in the map.

### CROSS-REFERENCE TO RELATED APPLICATION

This application claims the benefit of and priority to Korean Patent Application No. 10-2024-0178281, filed on Dec. 4, 2024, the entire contents of which are hereby incorporated herein by reference.

### TECHNICAL FIELD

The present disclosure relates to an apparatus and a method for displaying a route using drawing gestures.

### BACKGROUND

Navigation technology is a technology that guides a route to allow a vehicle or a pedestrian (hereinafter, referred to as a user) to reach a destination. Navigation may identify a user's current location through location tracking technology such as a global positioning system (GPS) and set a route based on map data. Various factors such as distance, estimated time, and traffic conditions are considered in a route setting process, and the user may efficiently reach the destination through navigation.

The conventional navigation system provides a function of setting a departure point, a waypoint, and a destination, but cannot directly select or designate a shape of a detailed route connecting each point designated by a user. For example, even though the user may prefer a particular road or may want to avoid a particular area, the conventional navigation system has a structure that makes it difficult to reflect the user's needs in detail.

The matters described in this Background section merely provide background information related to the present disclosure and do not necessarily constitute a related art already known to those having ordinary skill in the art.

### SUMMARY

Aspects of the present disclosure provide a technology that allows a user to directly designate a shape of a route connecting each point in addition to designating a departure point, a waypoint, and a destination. Aspects of the present disclosure may improve user experience of the navigation system and enable customized route setting.

Aspects of the present disclosure provide an apparatus and a method for determining a route from a departure point to a destination by using a touch on a touch display of a navigation device.

Aspects of the present disclosure provide an apparatus and a method for identifying (e.g., automatically identifying) a road link within a touched area to determine a route through a touch on a touch display of a navigation device.

Aspects of the present disclosure provide an apparatus and a method for allowing a user of a navigation device to designate a rough route from a departure point to a destination.

The objects of the present disclosure are not limited to those mentioned above. Other objects of the present disclosure, which are not mentioned herein, should be more clearly understood by those having ordinary skill in the art from the following description of the present disclosure.

According to an aspect of the present disclosure, a method for displaying route using drawing gestures is provided. The method includes determining a first route from a departure point to a destination by receiving a drawing gesture for determining the first route. The method also includes displaying information on the first route. The drawing gesture is formed by free movement of a touch point on a touch display of the navigation terminal that is displaying a map, and the free movement is movement of a touch point that is not limited to a road included in the map.

In some embodiments, the drawing gesture may generates a free curve on the map, where the free curve has a width, and the determining the first route may include identifying a road link in an inner area of the width of the free curve, and determining the first route by selecting the identified road link.

In some embodiments, determining the first route may include determining the width of the free curve before receiving the drawing gesture.

In some embodiments, determining the first route may include identifying a density of the road link within a reference value from the touch point at which the drawing gesture is formed, and determining the width of the free curve by using the identified density of the road link.

In some embodiments, determining the first route may include receiving a theme for the first route before determining the first route, identifying a theme score indicating suitability according to the theme for each road link, and selecting the road link by a combination with the highest sum of the theme score.

In some embodiments, determining the first route may include receiving a first drawing gesture for determining the destination, receiving a second drawing gesture for determining a shape of the first route from the departure point to the destination; determining the first route in a first area formed by the first drawing gesture, and determining the first route outside the first area based on a free curve formed by the second drawing gesture.

In some embodiments, determining the first route may include receiving a first drawing gesture for determining a waypoint, receiving a second drawing gesture for determining a shape of the first route from the departure point to the destination, determining the first route based on a free curve formed by the second drawing gesture, and the first route may include the waypoint determined by the first drawing gesture.

In some embodiments, determining a first route may include receiving a first drawing gesture for determining the first route from the departure point to the destination, receiving a second drawing gesture for modifying the first route, and generating a free curve on the map based on the first drawing gesture and the second drawing gesture, and determining the first route based on the free curve.

In some embodiments, displaying information on the first route may include displaying information on a second route from the departure point to the destination together with the first route. The second route may be determined independently from the drawing gesture.

According to the aforementioned and other embodiments of the present disclosure, there a method for displaying route using drawing gestures is provided. The method includes receiving a drawing gesture for determining a first route from a departure point to a destination from a navigation terminal. The method also includes selecting the first route from a plurality of candidate routes corresponding to the drawing gesture by using information on the drawing gesture. The method additionally includes transmitting information on the first route to the navigation terminal. The drawing gesture is formed by free movement of a touch point on a touch display of the navigation terminal that is displaying a map, and the free movement is movement of a touch point that is not limited to a road included in the map.

According to the aforementioned and other embodiments of the present disclosure, a method for displaying route using drawing gestures is provided. The method includes receiving a drawing gesture for changing an existing route displayed on a touch display of the navigation device. The method also includes determining a change route based on the existing route by using the drawing gesture. The method additionally includes displaying information related to the change route. The drawing gesture is formed by free movement of a touch point on the touch display of the navigation device that is displaying a map. The free movement is free movement of the touch point from a first point of the existing route to a second point different from the first point, and moves a point different from a route between the first point and the second point on the existing route. The free movement is movement of a touch point that is not limited to a road included in the map.

It should be noted that the effects of the present disclosure are not limited to those described above. Other effects of the present disclosure, that are not mentioned herein, should be more clearly understood by those have ordinary skill in the art from the following description.

### BRIEF DESCRIPTION OF THE DRAWINGS

The above and other aspects and features of the present disclosure should become more from the following detailed description taken in conjunction with the accompanying drawings, in which:

FIG. 1 is a schematic view illustrating a configuration of a route display system using a drawing gesture according to an embodiment of the present disclosure;

FIG. 2 is a view illustrating a drawing gesture in some embodiments of the present disclosure;

FIG. 3 is a flow chart illustrating a method for displaying a route using a drawing gesture according to an embodiment of the present disclosure;

FIG. 4 is a view illustrating a method for displaying a route using a drawing gesture according to some embodiments of the present disclosure;

FIG. 5 is a flow chart illustrating an operation of determining a route using a drawing gesture, that is described with reference to FIG. 3, according to an embodiment of the present disclosure;

FIGS. 6-11 are views illustrating a method for displaying a route using a drawing gesture according to some embodiments of the present disclosure;

FIG. 12 is a signal flow chart illustrating a method for displaying a route using a drawing gesture according to an embodiment of the present disclosure;

FIG. 13 is another flow chart illustrating a method for displaying a route using a drawing gesture according to an embodiment of the present disclosure;

FIG. 14 is a view illustrating a method for displaying a route using a drawing gesture, that is described with reference to FIG. 13, according to an embodiment of the present disclosure;

FIG. 15 is another signal flow chart illustrating a method for displaying a route using a drawing gesture according to an embodiment of the present disclosure;

FIG. 16 is a view illustrating a method for displaying a route in some embodiments of the present disclosure; and

FIG. 17 is a block diagram illustrating a hardware configuration of a computing device used in some embodiment of the present disclosure.

### DETAILED DESCRIPTION

Hereinafter, embodiments of the present disclosure are described in detail with reference to the accompanying drawings. Advantages and features of the present disclosure and methods of accomplishing the same should be more clearly understood from the following detailed description taken in conjunction with the accompanying drawings. The present disclosure may, however, be embodied in many different forms and should not be construed as being limited to the embodiments set forth herein. Rather, these embodiments are provided to make the present disclosure thorough and complete and to fully convey the concepts of the present disclosure to those having ordinary skill in the art, and the present disclosure is defined only by the appended claims.

In adding reference numerals to the components of each drawing, it should be noted that the same reference numerals are assigned to the same components as much as possible even when the components are shown in different drawings. In addition, in describing the present disclosure, where it was determined that a detailed description of the related well-known configuration or function would obscure the gist of the present disclosure, the detailed description thereof has been omitted.

Unless otherwise defined, all terms used in the present specification (including technical and scientific terms) may be used in a sense that can be commonly understood by those having ordinary skill in the art. In addition, the terms defined in the commonly used dictionaries should not be ideally or excessively interpreted unless the terms are specifically defined otherwise herein. The terminology used herein is for the purpose of describing particular embodiments only and is not intended to be limiting of the disclosure. In this specification, the singular also includes the plural unless specifically stated otherwise in the phrase.

In addition, in the following description, terms such as first, second, A, B, (a), (b), may be used. These terms are used merely to distinguishing the components from other components, and the nature or order of the components are not limited by the terms. If a component is described as being “connected,” “coupled” or “contacted” to another component, the component may be directly connected to or contacted with the other component, but it should be understood that another component also may be “connected,” “coupled” or “contacted” between the two component.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

Hereinafter, embodiments of the present disclosure are described in detail with reference to the accompanying drawings.

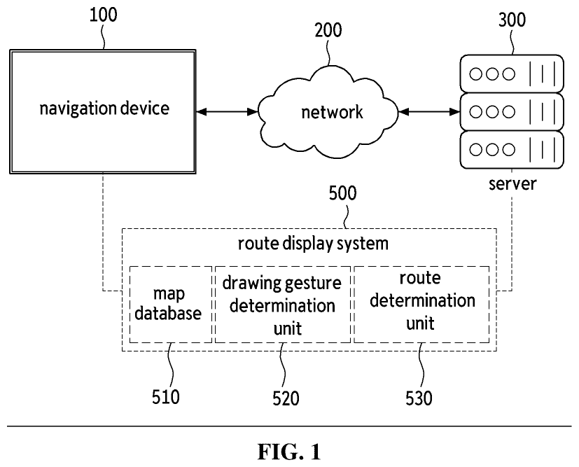

A configuration and operation of a system for displaying a route using a drawing gesture according to an embodiment of the present disclosure is described in more detail with reference to the schematic view illustrated in FIG. 1.

Referring to FIG. 1, a system for displaying a route (hereinafter, referred to as a route display system) using a drawing gesture, according to an embodiment of the present disclosure, may include at least one of a navigation device 100, a network 200, or a server 300. In an embodiment, the route display system 500 may be included only in the navigation device 100. In another embodiment, the route display system 500 may be included only in the server 300. The route display system 500 may include a map database 510, a drawing gesture determination unit 520, and a route determination unit 530.

The navigation device 100 according to an embodiment of the present disclosure may include a display capable of being touched (e.g., a “touch display”). A user of the navigation device 100 may touch a touch display of the navigation device 100 by using a hand or a pen. A portion that the display and the user's hand or pen touch may be referred to as a touch point. The user may perform a drawing gesture by moving the touch point.

The drawing gesture may be formed by free movement of the touch point on the touch display of the navigation device 100 that is displaying a map. When the user freely moves the touch point, a free curve may be formed in accordance with a movement trajectory of the touch point. The user's gesture on the display that forms such a free curve may be referred to as a drawing gesture. In addition, a gesture in which the user marks a dot on the display without moving the touch point may be referred to as a drawing gesture.

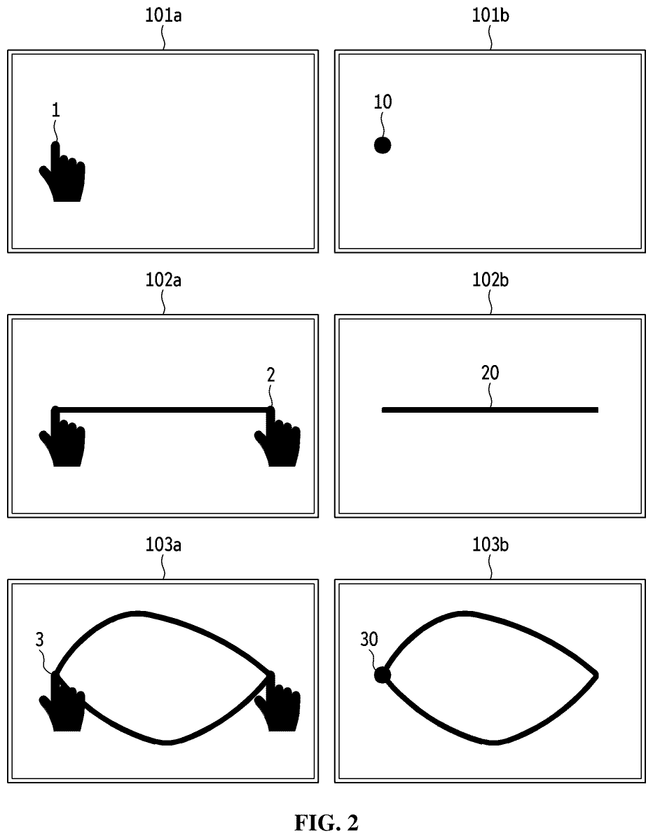

For example, as shown in FIG. 2, the user may touch (1) a portion of a touch display 101a of the navigation device. As a result of the touch (1), a dot 10 may be displayed on a touch display 101b. Also, the user may move (2) the touch point to form a line on a touch display 102a of the navigation device. As a result of the movement (2) of the touch point, a line 20 may be displayed on a touch display 102b. Also, the user may move (3) the touch point to form a closed curve on a touch display 103a of the navigation device. As a result of the movement (3) of the touch point, a closed curve 30 may be displayed on a touch display 103b. As in the above example, the drawing gesture may be understood as a gesture that freely moves the touch point on the touch display to generate a dot or a line on the touch display.

In addition, unlike a conventional navigation device, the navigation device 100 may determine a route by using the user's drawing gesture and display information (e.g., route display on a map, a distance of the route, and the expected driving time when driving on the route) related to the determined route.

In addition, the navigation device 100 may include a computing device with a touch display embedded in a vehicle, a computing device (e.g., a vehicle navigation device, and a smartphone with a navigation application) with a touch display that may be separately attached to the vehicle, and a computing device (e.g., a smartphone, and a tablet computer)with a touch display that the user is using to check the route.

Referring back to FIG. 1, the server 300 according to an embodiment of the present disclosure may receive information for determining and displaying a route including a drawing gesture input to the navigation device by the user through the network 200. In addition, the server 300 may determine a route by using information including a drawing gesture. In addition, the server 300 may transmit a signal for displaying information related to the determined route on the display of the navigation device 100 to the navigation device 100 through the network 200. The user may determine a route by viewing the information related to the route transmitted by the server 300 through the display of the navigation device 100.

The network 200 according to an embodiment of the present disclosure refers to all types of networks that transmit and receive signals between the navigation device 100 and the server 300 when signal transmission and reception between the navigation device 100 and the server 300 is required.

The map database 510 of the route display system 500 according to an embodiment of the present disclosure may include information on a map related to the route displayed by the navigation device. Also, the map database 510 may include information on road links and nodes on the map. In addition, the map database 510 may include information on a theme score for each road link.

The drawing gesture determination unit 520 according to an embodiment of the present disclosure may determine whether the drawing gesture described below is a drawing gesture for determining a route, a drawing gesture for designating a destination, a drawing gesture for designating a waypoint, or a drawing gesture for modifying a route.

The route determination unit 530 according to an embodiment of the present disclosure may determine a route using a drawing gesture that is described in more detail below. In addition, the route determination unit 530 may determine a change route in which the existing route is changed.

The components of the route display system according to an embodiment of the present disclosure have been described with reference to FIG. 1. It should be noted that the operation of each component of the route display system is not limited to the above-described example, and may include an operation related to a method for displaying a route (hereinafter, referred to as a route display method) using a drawing gesture according to some embodiments of the present disclosure, which is described in more detail below. In addition, the technical spirits that may be grasped through some embodiments of the present disclosure, which are described in more detail below, may be applied to the route display system described above even though there is no separate description.

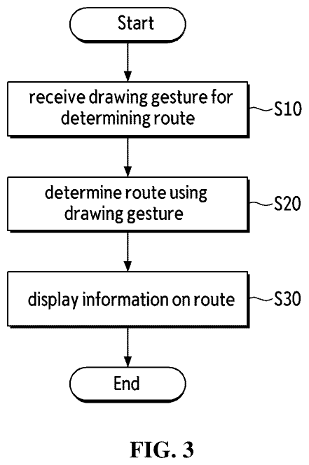

FIGS. 3-16 are views illustrating a route display method according to some embodiments of the present disclosure. Hereinafter, the route display method according to some embodiments of the present disclosure is described in more detail with reference to FIGS. 3-16 .

For reference, the route display method according to embodiments of the present disclosure may be performed by one or more computing devices. For example, the route display method may be generated by two or more computing devices. Some methods included in the route display method may be performed by a first computing device, and the other methods included in the route display method may be performed by a second computing device.

In an embodiment, the computing device may be the navigation device and/or the navigation server described above with reference to FIG. 1. In the following description, the subject of a specific step/operation may be omitted, and in this case, it may be understood that the corresponding step/operation is performed by the computing device.

In addition, it is noted that the embodiments related to the route display system described with reference to FIG. 1 may be applied to the route display method according to the embodiments described below even though there is no separate description.

FIG. 3 is a flow chart illustrating a route display method according to an embodiment of the present disclosure. Hereinafter, the route display method according to an embodiment is described in more detail with reference to FIG. 3.

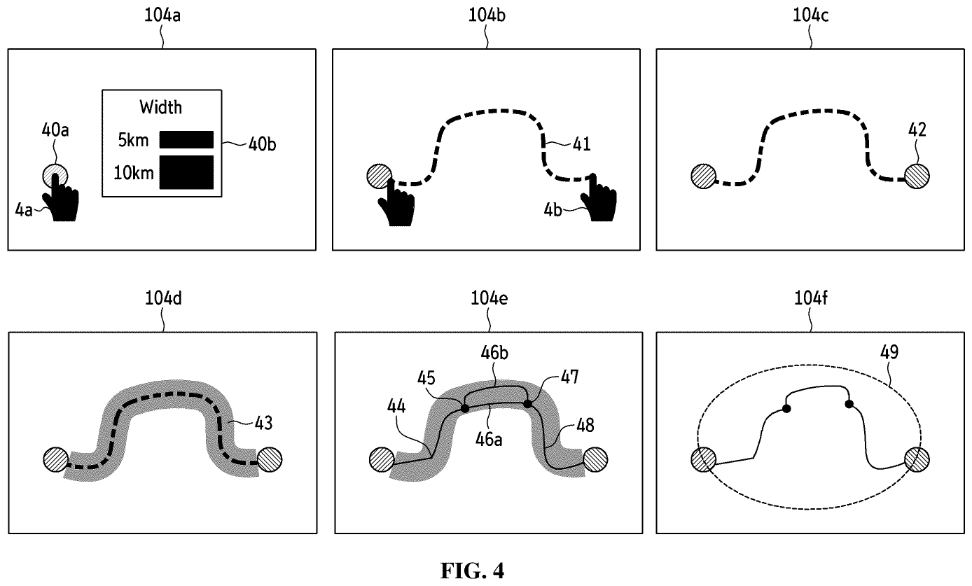

In an operation S10, a drawing gesture for determining a route from a departure point to a destination may be input. For example, as shown in FIG. 4, a touch point may be generated by a touch 4a on a touch display 104a of the navigation device that is displaying a map. In addition, a place where the touch point is generated may be determined as a departure point 40a. Subsequently, on a touch display 104b, the touch point may be moved while drawing a trajectory 41 by a drawing gesture 4b. Then, when the touch point disappears due to the termination of the touch on a touch display 104c, a place where the touch point disappears may be determined as a destination 42. In addition, on a touch display 104d, a free curve 43 may be generated based on the trajectory 41 drawn by the touch point while moving. For example, the free curve 43 may be a curve in which a width of a preset value exists based on the movement trajectory 41 of the touch point.

It should be noted that the free movement of the touch point is not limited to the road included in the map. For example, as shown in FIG. 4, a plurality of roads 44, 46a, 46b and 48 may be identified within the free curve. The identified roads 44, 46a, 46b and 48 and the movement trajectory of the touch point may not match. In other words, the touch point may be freely moved to a place other than the road, and even when the touch point is freely moved to a place other than the road, the route according to the present disclosure may be determined.

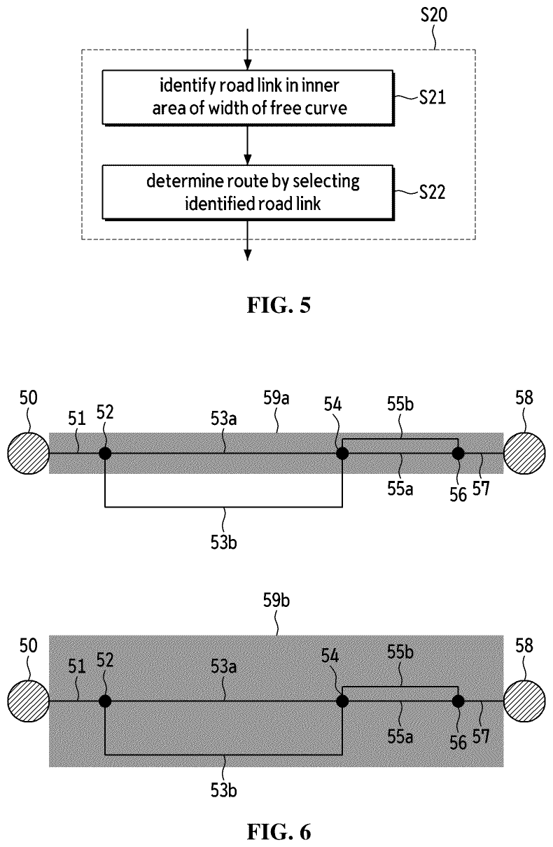

Referring back to FIG. 3, in an operation S20, the route may be determined using a drawing gesture. In an operation S30, information on the determined route may be displayed on the navigation device. For example, as shown in FIG. 4, a route 49 may be determined using the free curve 43 generated by the drawing gesture on the touch display 104d. In detail, the roads 44, 46a, 46b and 48 located within the width of the free curve 43 displayed on a touch display 104e may be selected. A route may be determined by combining the selected roads, and the route 49 may be displayed as in a touch display 104f. The selected roads may be understood as the road 44, the road 46b and the road 48. A detailed method for determining a route, according to an embodiment, is described below with reference to FIG. 5.

Also, as the information on the determined route, information on an optimal route from the departure point to the destination may be displayed. The user may recognize the information (e.g., display of the optimal route on the display, distance of the optimal route, and expected driving time when driving on the optimal route) on the optimal route and select the determined route and the optimal route by using a drawing gesture.

Accordingly, in the route display method according to an embodiment, it may be understood that after a drawing gesture indicating an approximate shape of a route on the touch display of the navigation device is received, a route is determined based on the received drawing gesture, and the determined route and information related to the route are displayed. In this case, the approximate shape of the route may mean a shape of a route formed by a drawing gesture even though the user does not designate a detailed waypoint or destination. Accordingly, it should be understood that a detailed route may be automatically determined in accordance with the present disclosure even though the user designates the approximate shape of the route.

FIGS. 5-11 are detailed views illustrating each operation of the route display method described with reference to FIG. 3. Hereinafter, a detailed example of each operation of the route display method according to some embodiments of the present disclosure is described in more detail with reference to FIGS. 5-11 .

FIG. 5 is a flow chart illustrating an operation S20 of determining a route using a drawing gesture, that is described with reference to FIG. 3. Hereinafter, a detailed example of the operation S20 of determining a route using a drawing gesture is described with reference to FIG. 5.

In an operation S21, a road link may be identified in an inner area of a width of a free curve generated on a map by a drawing gesture. The road link refers to a road between nodes. The node may be understood as an intersection point with another road link, a departure point, or a destination.

For example, as shown in FIG. 6, nodes 50, 52, 54, 56 and 58 and road links 51, 53a, 53b, 55a, 55b and 57 may be displayed. In this case, the first node 50 is a departure node, the fifth node 58 is a destination node, and the second to fourth nodes 52 to 56 are intersection nodes. Road links identified in an inner area of a width of a free curve 59a are the first road link 51, the second road link 53a, the fourth road link 55a, the fifth road link 55b, and the sixth road link 57. When a width of a free curve 59b is increased, the road links identified in an inner area of the width of the free curve 59b are the first road link 51, the second road link 53a, the third road link 53b, the fourth road link 55a, the fifth road link 55b, and the sixth road link 57. That is, it may be understood that more road links may be identified in the inner area of the width of the free curve as the width of the free curve is wider.

In one embodiment, the width of the free curve may be determined before the drawing gesture is input. For example, as shown in FIG. 4, the departure point 40a may be determined by the touch 4 a for a touch display 104, and a pop-up 40b for selecting the width of the free curve may be displayed together. Afterwards, the free curve may be generated with the width (e.g., 5 kilometers (km), 10 km) selected from the displayed pop-up 40b.

In one embodiment, the width of the free curve may be automatically determined. For example, after the density of a road link within a reference value is identified from the touch point at which the drawing gesture is formed, when the density of the road link is higher than a preset reference, the width of the free curve may be reduced from a preset value. In addition, when the density of the identified road link is lower than a preset reference, the width of the free curve may be increased from the preset value. When the density of the road link is high, the number of road links that may be selected may be sufficient even though the width of the free curve decreases. However, when the density of the road link is low, the number of road links that may be selected within the width of the free curve, which has the preset value, may not be sufficient, or there may be no road link itself.

Therefore, the width of the free curve may be automatically determined so that a road link of a certain range may exist in the inner area of the width of the free curve. Also, in areas with a high density of road links, too many road links may be identified in the inner area of the width of the free curve, and overload may occur in a computation required to select a road link and determine a route due to too many road links. Therefore, to prevent such overload, the width of the free curve may be automatically determined to limit the number of road links.

Referring back to FIG. 5, in an operation S22, a route may be determined by selecting the identified road link. For example, as shown in FIG. 4, three road links 44, 46b and 48 may be selected from the touch display 104e of the navigation device. Subsequently, the route 49 may be determined by a combination of the selected road links 44, 46b and 48.

In one embodiment, the road link may be selected so that similarity between the route and the movement trajectory of the touch point is to be the highest. In this case, selecting a road link so as to increase the similarity between the route and the movement trajectory of the touch point may be, for example, selecting a road link having a close average distance to the movement trajectory of the touch point among the identified road links. For another example, selecting a road link to increase the similarity between the route and the movement trajectory of the touch point may be selecting a road link having the smallest difference in slope from the movement trajectory of the touch point among the identified road links.

In one embodiment, the road link may be selected so that the sum of theme scores is maximized. The theme score means a score according to a theme of the road link. For example, the theme of the road link may be a scenic road (hereinafter, referred to as a landscape road). Therefore, a score may be determined for each road link as a scenic road. When natural objects (e.g., beaches, mountains, and rivers) or attractions (e.g., sculptures, landmarks) exist adjacent to the road link, the score may be determined higher than that of a general road link. For another example, the theme of the road link may be a road with a view of a beach road or an attraction. For another example, the theme of the road link may be a road that does not have congestion or the shortest road (hereinafter, economic road).

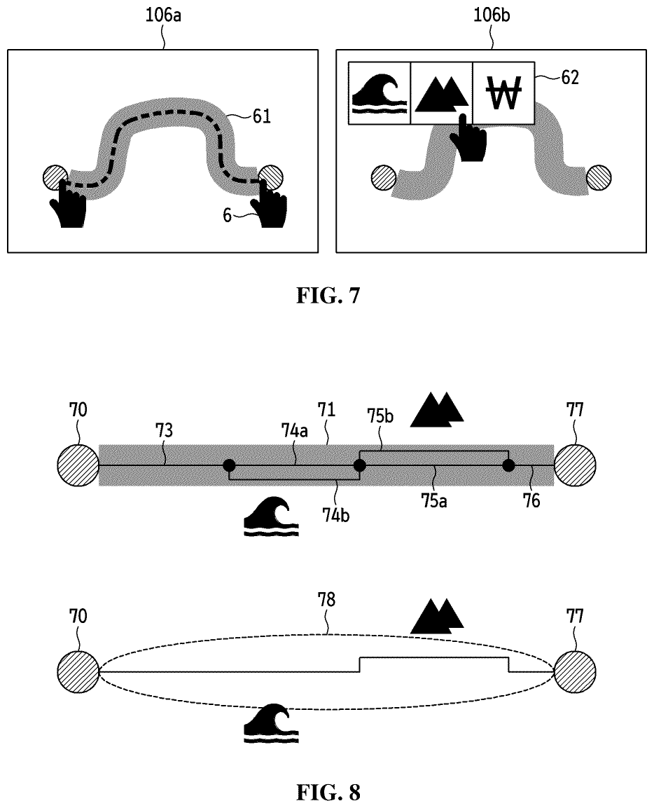

In detail, a free curve is generated by a drawing gesture, and before a route is determined, a theme (e.g., a landscape road, an economic road) for the route may be input. For example, as shown in FIG. 7, a free curve 61 may be generated by a drawing gesture 6 on a touch display 106a of the navigation device. Before the route is determined, an icon 62 representing a theme for the route may be displayed on the touch display 106b of the navigation device. In this case, a route corresponding to a wave-shaped icon may be determined to pass through the beach road. In addition, a route corresponding to a mountain-shaped icon may be determined to pass through the mountain. In addition, a route corresponding to an icon indicating currency may be determined to have the lowest fuel efficiency.

Subsequently, with respect to each road link identified in the inner area of the width of the free curve, a theme score for an input theme may be identified. For example, as shown in FIG. 8, a plurality of road links 73, 74a, 74b, 75a, 75b and 76 may be identified in an inner area of a width of a free curve 71. A theme score for a theme may be identified for each road link. In detail, the beach road link 74 b may have a theme score of 1 for the sea. Also, the road link 75 b adjacent to the mountain may have a theme score of 1 for the mountain.

Subsequently, each road link may be selected with a combination in which the sum of theme scores is maximized. For example, as shown in FIG. 8, when a theme for the mountain is input, a route may be determined by selecting the road link 75b adjacent to the mountain so that a theme score for the mountain is to be the highest. In detail, a plurality of road links 73, 74a, 75b and 76 including the road link 75b adjacent to the mountain in FIG. 8 may be selected to determine a route 78.

As another example, when the input theme is a landscape road, in FIG. 8, a route may be determined by necessarily including the beach road link 74b and the road link 75b adjacent to the mountain. For another example, when the input theme is an economic road, in FIG. 8, road links 73, 74a, 75a, and 76 may be selected to provide the shortest distance from a departure point 70 to a destination 77 without including the beach road link 74b and the road link 75b adjacent to the mountain.

Accordingly, the theme score according to the theme may be matched to each road link, and the route may be determined using the theme score for the input theme. Through this route determination operation, the route may be quickly determined without unnecessary computation.

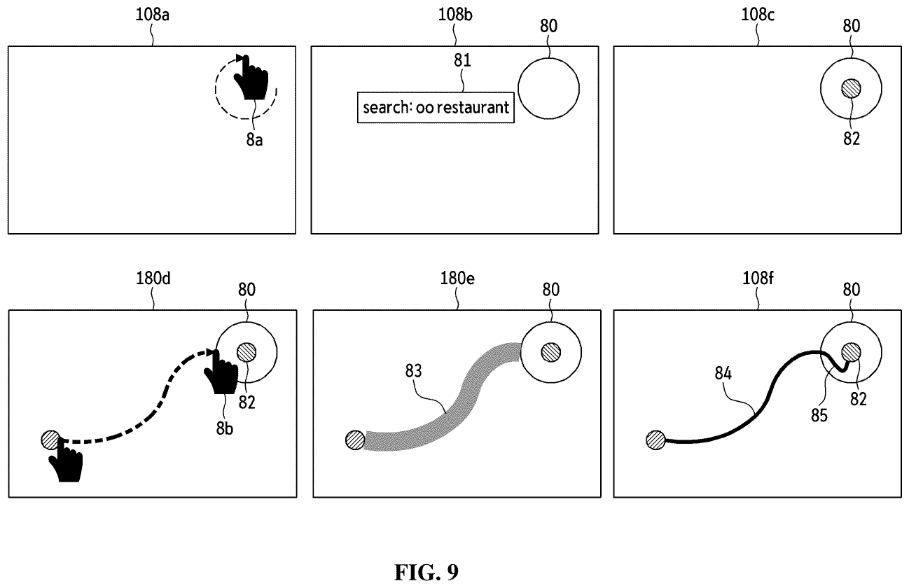

The detailed example of each operation of the route display method described with reference to FIG. 3 has been described as above. The drawing gesture may be used not only for simply determining the shape of the route but also for other purposes. Hereinafter, an additional drawing gesture is described with reference to FIGS. 9-11 .

FIG. 9 is a view illustrating a drawing gesture for determining a destination in relation to a route display method according to an embodiment of the present disclosure. Hereinafter, an additional drawing gesture for designating a destination is described with reference to FIG. 9.

First, a first drawing gesture for determining a destination may be input. For example, as shown in FIG. 9, on a touch display 108a of the navigation device, a drawing gesture 8a for drawing a closed curve may be input. Subsequently, on a touch display 108b, a circular first free curve 80 may be generated based on the drawing gesture 8a. In addition, while the first free curve 80 is being generated, a search word input pop-up 81 capable of determining a destination may be displayed together. When a destination is input to the search word input pop-up 81, a destination 82 located inside an area surrounded by the first free curve 80 may be determined, and may be displayed on a touch display 108c.

Since the scale of the map displayed on the touch display of the navigation device is small, a map of a wide area may be displayed. When a specific destination is designated on the map of the wide area through a touch, the touched place and a location of the destination may not match. Accordingly, a drawing gesture for determining an area in which the destination exists may be performed to form a free curve, and the destination may be input to the search word input pop-up so that a destination existing inside the free curve may be displayed. That is, the user may easily select a destination from the map of the wide area.

Next, a second drawing gesture for determining a shape of the route may be input. In this case, the second drawing gesture may be formed by free movement of a touch point from the departure point to a first free curve generated by the first drawing gesture. For example, as shown in FIG. 9, a second drawing gesture 8b for free movement of the touch point may be performed on a touch display 108d. In this case, the second drawing gesture 8b may be formed by free movement of the touch point from the departure point to the first free curve 80. That is, the route may be determined even though the touch point does not move to the destination 82 located in the area surrounded by the first free curve 80.

Next, a route from the departure point to the first free curve may be determined and displayed based on a second free curve formed by the second drawing gesture. Subsequently, a route from the first free curve formed by the first drawing gesture to the destination may be automatically determined. In this case, the route from the departure point to the first free curve is determined based on the first free curve, but the route from the first free curve to the destination may be automatically determined in accordance with a preset reference. For example, the route from the first free curve to the destination may be determined as the shortest route.

For example, as shown in FIG. 9, a second free curve 83 may be generated by the second drawing gesture on a touch display 108e. Subsequently, a first route 84 generated using the second free curve may be determined and displayed on a touch display 108f. In addition, a second route 85 from the first free curve 80 to the destination 82 may be automatically determined and displayed on the touch display 108f. In this case, the first route 84 and the second route 85 may be determined to be connected to each other.

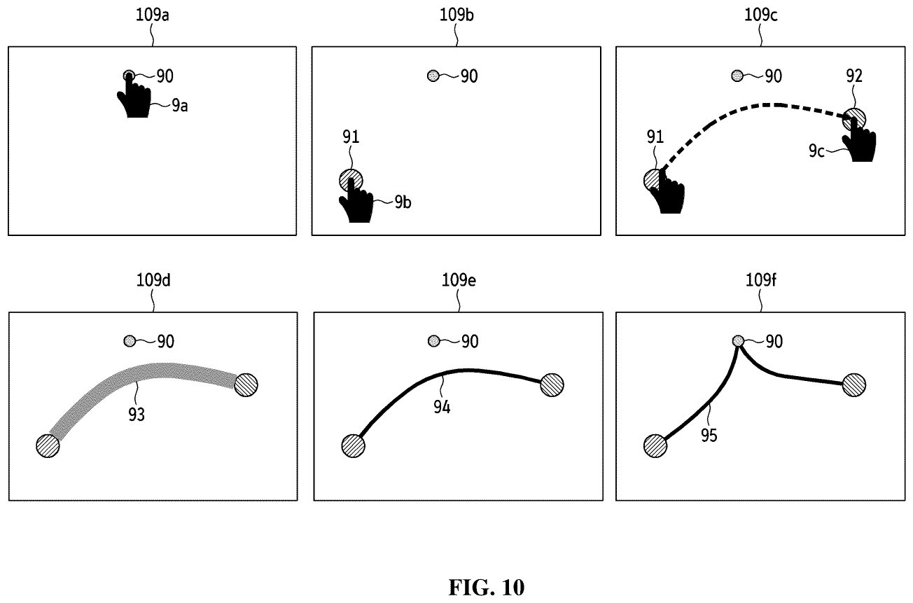

FIG. 10 is a view illustrating a drawing gesture for designating a waypoint in a route display method according to an embodiment of the present disclosure. Hereinafter, an additional drawing gesture for designating a waypoint is described with reference to FIG. 10.

First, a first drawing gesture for determining a waypoint may be input. For example, as shown in FIG. 10, a point at which a touch point is generated by a touch 9a for a touch display 109a may be determined and displayed as a waypoint 90. In this case, the touch in which the waypoint is determined may be distinguished from the touch in which the departure point is determined. For example, the touch in which the waypoint is determined may be a touch that a drawing gesture for freely moving the touch point after the touch has not been performed. For another example, the touch in which the waypoint is determined may be a touch having a long touch duration, unlike the touch in which the departure point is determined.

Next, a second drawing gesture for determining a first route from the departure point to the destination may be input. For example, as shown in FIG. 10, on a touch display 109b, after the waypoint 90 is determined and displayed, a point at which a touch point is generated by a touch 9b may be determined and displayed as a departure point 91. Subsequently, a drawing gesture 9c for freely moving the touch point from the departure point 91 to a destination 92 may be performed on a touch display 109c. In this case, the drawing gesture 9c may be formed by free movement of a touch point that does not pass through a point corresponding to the waypoint 90. That is, it may be understood that a route may be determined even though a drawing gesture is performed regardless of passing through a point corresponding to a waypoint.

Next, a route may be determined based on a free curve generated by the second drawing gesture. The route may include a waypoint. For example, as shown in FIG. 10, a free curve 93 may be generated on a touch display 109d by using a drawing gesture. In this case, the waypoint 90 may exist outside a width of the free curve 93. Subsequently, a road link located inside the width of the free curve 93 may be selected so that a route 94 may be determined. When the determined route 94 does not include the waypoint 90, the route 94 may be adjusted to include the waypoint 90 so that a new route 95 may be determined based on the determined route 94. As a detailed example, in order that the determined route 94 includes the waypoint 90, a road link closest to the waypoint 90 may be additionally selected so that the route 95 may be determined. In this case, the additionally selected road link may not be located in the inner area of the width of the free curve 93.

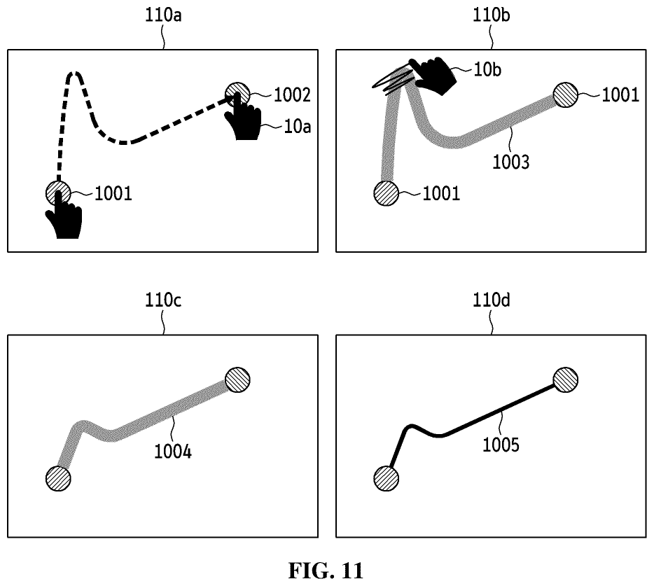

FIG. 11 is a view illustrating a drawing gesture for modifying a route in a route display method according to one embodiment of the present disclosure. Hereinafter, an additional drawing gesture for modifying a route is described with reference to FIG. 11.

First, a first drawing gesture for determining a first route from the departure point to the destination may be input. Subsequently, a first free curve may be generated using the first drawing gesture. For example, as shown in FIG. 11, a first drawing gesture 10a for determining a route may be performed on a touch display 110a. In this case, the first drawing gesture 10a may be formed by free movement of a touch point from a departure point 1001 to a destination 1002. Subsequently, on a touch display 110b, a free curve 1003 may be generated using the first drawing gesture 10a.

Next, a second drawing gesture for modifying a route may be input. For example, as shown in FIG. 11, on the touch display 110b, a second drawing gesture 10b may be performed for a portion of the free curve for determining a route. In this case, the second drawing gesture 10b may be formed by repeating left and right movement of the touch point by a reference value or more. In addition, the second drawing gesture 10b may be applied only when it is performed within a reference value after the first drawing gesture 10a is performed. The second drawing gesture may thus include all drawing gestures distinguished from the first drawing gesture without being limited to the above-described example.

Next, a free curve may be generated based on the first drawing gesture and the second drawing gesture. For example, as shown in FIG. 11, on a touch display 110c, the free curve 1003 generated by the first drawing gesture 10a may be modified by the second drawing gesture 10b to display a new free curve 1004. In detail, the free curve 1003 may be modified to exclude a portion for which the second drawing gesture 10b is performed.

Next, the route may be determined based on the modified free curve. For example, as shown in FIG. 11, on a touch display 110d, a route 1005 may be determined based on the modified free curve 1004 instead of the existing free curve 1003. In detail, a road link located in an inner area of a width of the modified free curve 1004 may be selected so that the route 1005 may be determined.

This route display method allows the user to immediately modify a free curve when recognizing that the free curve is incorrectly generated after generating the free curve by using a drawing gesture. In addition, this route display method may modify the free curve to determine the route by using another drawing gesture.

The route display method according to some embodiments of the present disclosure has been described as above. The route display method of the present disclosure may determine a route by using a drawing gesture, unlike the route display method in the conventional navigation device. The conventional navigation device may select a departure point, a destination, and a waypoint, but cannot select a detailed shape of a route connecting the departure point, the destination, and the waypoint. The route display method of the present disclosure makes it possible to select a detailed shape of a route connecting a departure point, a destination, and a waypoint.

In addition, the drawing gesture on the map representing a wide area may have difficulty in designating a detailed road or destination. The route display method according to an embodiment of the present disclosure may generate a free curve by using a drawing gesture, and may determine a route by selecting a road link in an inner area of a width of the free curve. Accordingly, even though the user does not recognize a detailed location of the road and locations of the departure point, the destination and the waypoint on the map displayed on the display of the navigation device, the route may be determined using the user's drawing gesture. Accordingly, the route display method of the present disclosure may enable a route determination suitable for the user's intention compared to the related art.

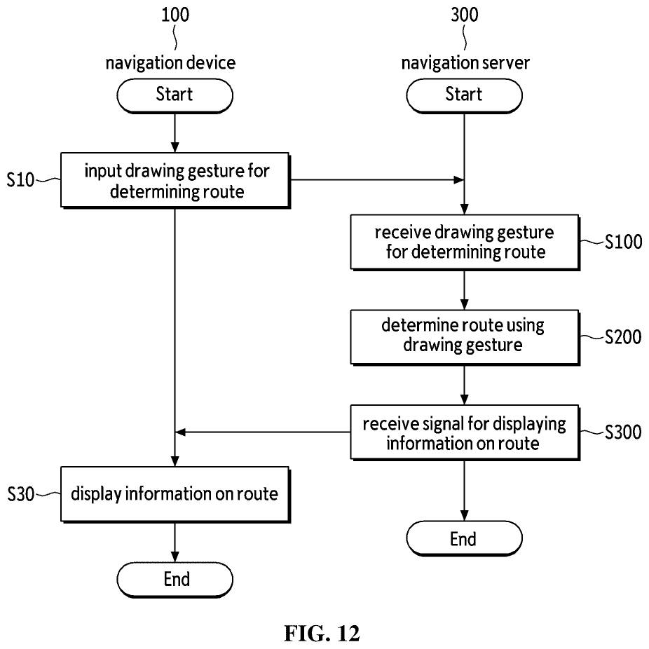

In the route display method according to some embodiments of the present disclosure, the server may receive information on the drawing gesture from the navigation device, perform computation for determining a route by using the received information and display the route on the navigation device as a result of the performed computation. Hereinafter, a route display method in a server is described with reference to FIG. 12.

In the operation S10, a drawing gesture for determining a route in a navigation device (e.g., a vehicle navigation terminal) may be input. The input drawing gesture and information (e.g., a free curve generated by the drawing gesture, a width of the free curve, and a road link identified in an inner area of a width of the free curve) related to the drawing gesture may be transmitted to a navigation server. Accordingly, in an operation S100, the navigation server may receive a drawing gesture for determining a route and information related to the drawing gesture.

In an operation S200, the navigation server may determine a route by using the drawing gesture and the information related to the drawing gesture. In this case, the server may generate a plurality of candidate routes corresponding to the drawing gesture by using the information on the drawing gesture, and may determine a route by selecting one from the plurality of candidate routes. In an operation S300, the navigation server may transmit a signal for displaying information on the determined route on the navigation device to the navigation device. The server may thus transmit the information on the determined route to the navigation device.

In the operation S30, the navigation device may receive the signal transmitted from the navigation server and display the information on the route. The display of the information on the route on the navigation device is the same as described above, and thus its description has been omitted below.

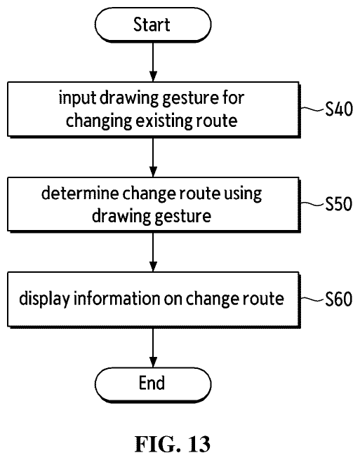

The user of the navigation device may want to modify the existing route determined by the navigation device. Therefore, a method of modifying and displaying a route, that is determined by the navigation device, by a drawing gesture, according to an embodiment, is described below with reference to FIGS. 13-16 .

FIG. 13 is another flow chart illustrating a route display method according to an embodiment of the present disclosure.

In an operation S40, a drawing gesture for changing an existing route displayed on the touch display of the navigation device may be input. In this case, changing the existing route may include changing the entire existing route and changing a portion of the existing route.

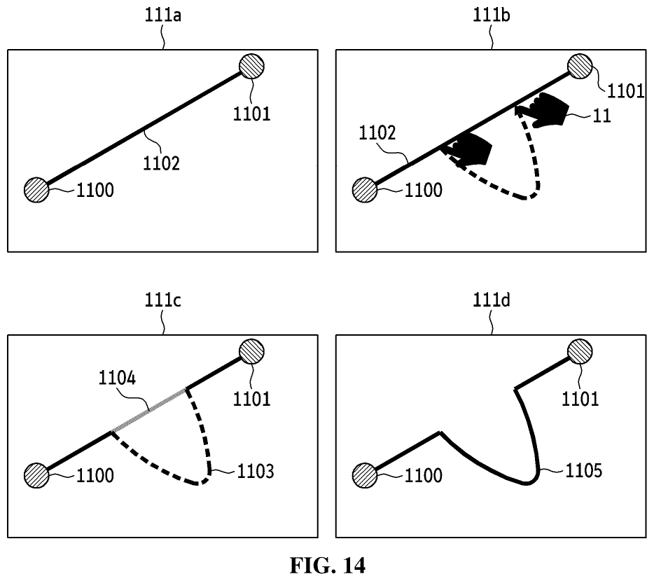

For example, as shown in FIG. 14, an existing route 1102 may be displayed on a touch display 111a of the navigation device. Subsequently, a drawing gesture 11 for changing the existing route 1102 may be input on a touch display 111b. The drawing gesture 11 may be formed by free movement of a touch point on the touch display 111b. The free movement may be free movement of the touch point from a first point of the existing route 1102 to a second point of the existing route. Each of the first point and the second point may be a point on the existing different routes. However, the free movement means movement of a point different from the route between the first point and the second point on the existing route. That is, the case of making a drawing gesture in the same manner as the existing route is excluded.

In an operation S50, a change route based on the existing route may be determined using the drawing gesture. For example, as shown in FIG. 14, a new road link 1103 may be selected and displayed on a touch display 111c based on the drawing gesture 11. Subsequently, a road link 1104 that may be replaced with the new road link 1103 may be removed from the existing route 1102, and the new road link 1103 may be added so that a change route 1105 may be determined.

In an operation S60, information related to the change route may be displayed on the touch display. The information related to the change route may be the change route itself. In addition, the information related to the change route may include a distance of the change route and an expected driving time when driving is performed on the change route.

Accordingly, in an embodiment, the existing route displayed by the navigation device may be changed to conform to the user's intention of the navigation device. In addition, in this embodiment, the existing route may be easily and intuitively changed through the drawing gesture.

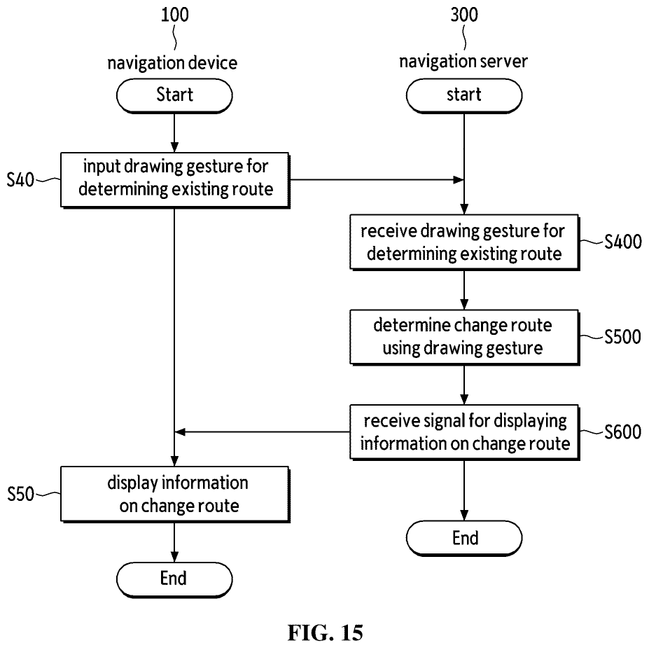

In addition, the present embodiment may be performed by the navigation server. Hereinafter, a route display method according to an embodiment of the present disclosure, that is performed by the navigation server, is described with reference to FIG. 15.

In the operation, a drawing gesture for changing the existing route displayed by the navigation device may be input. The navigation device may transmit the input drawing gesture and information related to the drawing gesture to the navigation server. Accordingly, in an operation S400, the navigation server may receive the drawing gesture and the information related to the drawing gesture.

In an operation S500, a change route based on the existing route may be determined using the drawing gesture and the information related to the drawing gesture. In this case, the operation of determining the change route may be the same as the operation of determining the change route, that is described with reference to FIG. 13. Accordingly, the server may generate a plurality of candidate change routes corresponding to the drawing gesture by using the information on the drawing gesture, and may determine the change route by selecting one from the plurality of candidate change routes.

In an operation S600, a signal for displaying the information related to the determined change route by the navigation device may be transmitted to the navigation device. The server may thus transmit the information on the determined route to the navigation device.

In the operation S50, the navigation device may display the information on the change route by receiving the transmitted signal.

The route display method according to some embodiments of the present disclosure has been described as above. In the route display method according to some embodiments of the present disclosure, when a route or a change route is displayed on the display of the navigation device, an optimal route from a departure point to a destination may be also displayed. In this case, the optimal route may mean a route to reach the destination from the departure point most quickly.

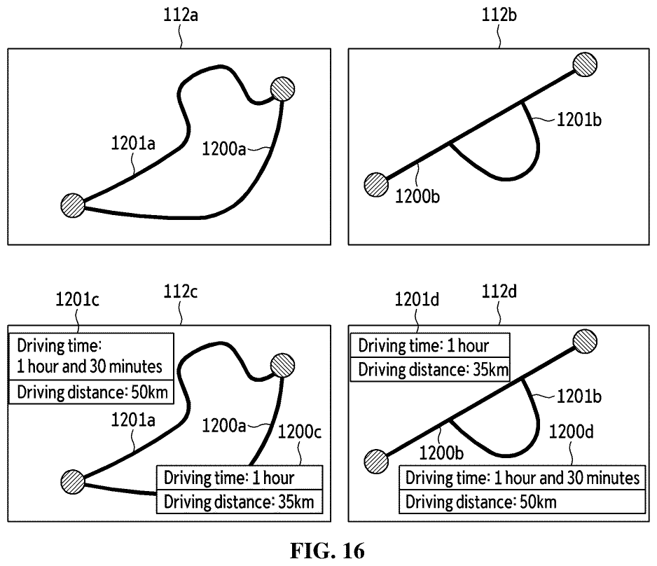

For example, as shown in FIG. 16, a route 1201a determined using the drawing gesture and an optimal route 1200a from a departure point to a destination may be displayed on a touch display 112a. In addition, as shown in FIG. 16, a change route 1201b determined using the drawing gesture and an optimal route 1200b from a departure point to a destination may be displayed on a touch display 112b.

In addition, information on a route or a change route, that is determined using the drawing gesture, and information on the optimal route from a departure point to a destination may be displayed together. For example, as shown in FIG. 16, a driving distance and a driving time 1201c of the route 1201a determined using the drawing gesture, and a driving distance and a driving time 1200c of the optimal route 1200a may be displayed together on a touch display 112c. In addition, as shown in FIG. 16, a driving distance and a driving time 1201d of the change route 1201b determined using the drawing gesture, and a driving distance and a driving time 1200d of the optimal route 1200b may be displayed together on a touch display 112d.

Embodiments of the present disclosure may provide a function of allowing a user to set a route by directly drawing on the touch display of the navigation device. Therefore, compared to the related art, a route suitable for the user's intention may be determined. In addition, since the user may freely draw a route from a departure point to a destination, a desired route may be reflected in real time without being limited to a proposal of a preset route. Embodiments of the present disclosure may this facilitate user-customized route setting, and may expect an effect that may more faithfully meet the user's intention regarding how to reach a destination.

Also, according to embodiments of the present disclosure, since the route is determined by analyzing a road inside the free curve generated using the user's drawing gesture, a route calculation speed may be improved. Since the route determination method based on the user's drawing gesture checks only the road included in the inner area of the width of the free curve, the route may be quickly determined by checking only the necessary road without having to search for the entire road. Therefore, the process of determining a route may be simplified through the present disclosure, and even though the route is determined based on the drawing gesture, the speed of computation for determining a route may not be reduced.

Also, according to embodiments of the present disclosure, a destination and a waypoint, which are desired by the user, may be simply designated by an additional drawing gesture. The user may use the method for determining a route using a drawing gesture according to some embodiments of the present disclosure even though the destination or the waypoint is not accurately displayed on the map displayed by the display of the navigation device. Accordingly, the user may intuitively modify or generate the route, and may simply modify the existing route by only using the drawing gesture. Therefore, embodiments of the present disclosure may improve the user's convenience of the navigation device.

The effects according to the technical spirits of the present disclosure are not limited to those mentioned above, and other effects not mentioned herein should be more clearly understood by those having ordinary skill in the art from the content of the present disclosure.

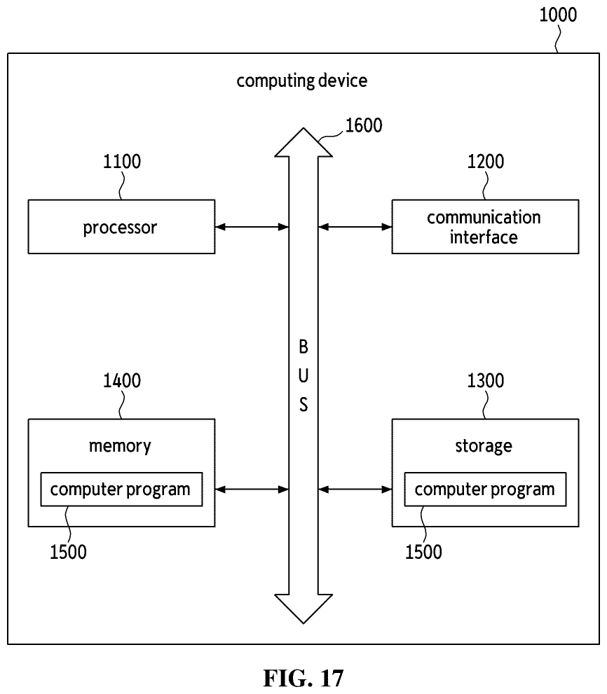

Hereinafter, a hardware configuration of an example computing device according to some embodiments of the present disclosure is described with reference to FIG. 17. The computing device may be a computing device on which the navigation device or the navigation server of the present disclosure is driven.

FIG. 17 is a block diagram illustrating a hardware configuration in which a computing device may be implemented in various embodiments of the present disclosure. A computing device 1000 according to the present embodiment may include one or more processors 1100, a system bus 1600, a communication interface 1200, a memory 1400 for loading a computer program 1500 performed by the processor 1100, and a storage 1300 for storing the computer program 1500. In FIG. 17, only components related to embodiments of the present disclosure are shown. Accordingly, it should be understood by those having ordinary skill in the art to which the present disclosure pertains that the computing device may further include other general-purpose components in addition to the components shown in FIG. 17.

The processor 1100 may control the overall operation of each component of the computing device 1000. The processor 1100 may include at least one of a central processing unit (CPU), a micro-processor unit (MPU), a micro controller unit (MCU), a graphic processing unit (GPU), or any type of processor well known in the technical field of the present disclosure. In addition, the processor 1100 may perform computation on at least one application or program for executing an operation/method according to various embodiments of the present disclosure. The computing device 1000 may include one or more processors.

The memory 1400 stores various types of contents, commands and/or information. The memory 400 may load one or more programs 1500 from the storage 1300 to execute the methods/operations according to various embodiments of the present disclosure. An example of the memory 1400 may be RAM, but is not limited thereto. The system bus 1600 provides a communication function between components of the computing device 1000.

The system bus 1600 may be implemented as various types of buses such as an address bus, a data bus, and a control bus. The communication interface 1200 supports wired/wireless Internet communication of the computing device 1000. The communication interface 1200 may support various communication methods other than Internet communication. To this end, the communication interface 1200 may be configured to include a communication module well known in the technical field of the present disclosure. The storage 1300 may non-temporarily store one or more computer programs 1500. The storage 1300 may include a nonvolatile memory such as a flash memory, a hard disk, a detachable disk, or any type of computer-readable recording medium well known in the art to which the present disclosure pertains.

The computer program 1500 may include one or more instructions in which methods/operations according to various embodiments of the present disclosure are implemented. When the computer program 1500 is loaded into the memory 1400, the processor 1100 may perform the methods/operations according to various embodiments of the present disclosure by executing one or more instructions.

For example, the computer program 1500 may include instructions to perform an operation of receiving a drawing gesture to determine a first route from a departure point to a destination, an operation of determining the first route by using the drawing gesture, and an operation of displaying information on the first route.

For another example, the computer program 1500 may include instructions to perform an operation of receiving a drawing gesture to change an existing route displayed on a display of a navigation device, an operation of determining a change route based on the existing route by using the drawing gesture, and an operation of displaying information on the change route.

Although the operations are shown in a specific order in the drawing, it should not be understood that the operations are necessarily executed in a specific order or sequential order shown or all illustrated operations are necessarily executed, to obtain a desired result. For example, in some situations, multitasking and parallel processing may be advantageous. Moreover, it should not be understood that the separation of various components in the above-described embodiments is necessarily required, and it should be understood that the described program components and systems may generally be integrated together into a single software product or packaged into multiple software products

Although the embodiments of the present disclosure have been described with reference to the accompanying drawings, it should be understood by those having ordinary skill in the art that the embodiments of the present disclosure can be embodied in other specific forms without departing from the technical spirits and essential characteristics. Thus, the above embodiments should be considered in all respects as illustrative and not restrictive. The scope of protection of the present disclosure should be interpreted by the following claims, and all technical spirits within the equivalent scope should be construed as being included in the scope of the technical spirits defined by the present disclosure.

What is claimed is:

1. A method for displaying a route of a navigation terminal by using a drawing gesture, the method comprising:
determining a first route from a departure point to a destination by receiving a drawing gesture for determining the first route; and
displaying information on the first route, wherein
the drawing gesture is formed by free movement of a touch point on a touch display of the navigation terminal that is displaying a map, and
the free movement is movement of a touch point that is not limited to a road included in the map.

2. The method of claim 1, wherein:
the drawing gesture generates a free curve on the map,
the free curve has a width, and
determining the first route includes:
identifying a road link in an inner area of the width of the free curve, and
determining the first route by selecting the identified road link.

3. The method of claim 2, wherein determining the first route includes determining the width of the free curve before receiving the drawing gesture.

4. The method of claim 2, wherein determining the first route includes:
identifying a density of the road link within a reference value from the touch point at which the drawing gesture is formed; and
determining the width of the free curve by using the identified density of the road link.

5. The method of claim 2, wherein determining the first route includes:
receiving a theme for the first route before determining the first route;
identifying a theme score indicating suitability according to the theme for each road link; and
selecting the road link by a combination with a highest sum of the theme score.

6. The method of claim 1, wherein determining the first route includes:
receiving a first drawing gesture for determining the destination;
receiving a second drawing gesture for determining a shape of the first route from the departure point to the destination;
determining the first route in a first area formed by the first drawing gesture; and
determining the first route outside the first area based on a free curve formed by the second drawing gesture.

7. The method of claim 1, wherein determining the first route includes:
receiving a first drawing gesture for determining a waypoint;
receiving a second drawing gesture for determining a shape of the first route from the departure point to the destination; and
determining the first route based on a free curve formed by the second drawing gesture,
wherein the first route includes the waypoint determined by the first drawing gesture.

8. The method of claim 1, wherein determining the first route includes:
receiving a first drawing gesture for determining the first route from the departure point to the destination;
receiving a second drawing gesture for modifying the first route;
generating a free curve on the map based on the first drawing gesture and the second drawing gesture; and
determining the first route based on the free curve.

9. The method of claim 1, wherein displaying information on the first route includes displaying information on a second route from the departure point to the destination together with the first route, wherein the second route is determined independently from the drawing gesture.

10. A method, performed by a computing device, for displaying a route using a drawing gesture, the method comprising:
receiving a drawing gesture for determining a first route from a departure point to a destination from a navigation terminal;
selecting the first route from a plurality of candidate routes corresponding to the drawing gesture by using information on the drawing gesture; and
transmitting information on the first route to the navigation terminal, wherein
the drawing gesture is formed by free movement of a touch point on a touch display of the navigation terminal that is displaying a map, and
the free movement is movement of a touch point that is not limited to a road included in the map.

11. A method for displaying a route of a navigation device by using a drawing gesture, the method comprising:
receiving a drawing gesture for changing an existing route displayed on a touch display of the navigation device;
determining a change route based on the existing route by using the drawing gesture; and
displaying information related to the change route, wherein:
the drawing gesture is formed by free movement of a touch point on the touch display of the navigation device that is displaying a map,
the free movement is free movement of the touch point from a first point of the existing route to a second point different from the first point, and moves a point different from a route between the first point and the second point on the existing route, and
the free movement is movement of a touch point that is not limited to a road included in the map.
